(19) United States
(12) Patent Application Publication
(10) Pub. No.: US 2025/0347144 A1
(43) Pub. Date: Nov. 13, 2025

(54) MOLDED FENCE PANELS WITH REINFORCEMENT INSERT

(71) Applicant: Alabama Metal Industries Corporation, Birmingham, AL (US)

(72) Inventors: Markus Erbeldinger, Pittsburgh, PA (US); Scotty A. Prejean, Duson, LA (US); Scott B. Galbraith, Bixby, OK (US)

(21) Appl. No.: 19/202,318

(22) Filed: May 8, 2025

Related U.S. Application Data
(60) Provisional application No. 63/645,201, filed on May 10, 2024.

(51) Int. Cl. E04H 17/16; B29C 70/26; B29C 70/48; B29K 305/00; B29L 31/00

(52) U.S. Cl. CPC E04H 17/1602; B29C 70/26; B29C 70/48; B29K 2305/00; B29L 2031/73

(57) ABSTRACT

A method for forming a fence panel includes providing a mold including a cavity configured to receive a molten material. The molten material is injected into the cavity of the mold and flows within the cavity of the mold. After injecting the molten material into the cavity of the mold, and with the molten material cooled to harden, a formed fence panel is removed from the cavity of the mold. The formed fence panel includes a first portion having a pattern of apertures extending through the formed fence panel and a second portion having a continuous outer surface at least at a first side of the formed fence panel.

### CROSS REFERENCE TO RELATED APPLICATION

The present application claims the filing benefits of U.S. provisional application Ser. No. 63/645,201, filed May 10, 2024, which is hereby incorporated herein by reference in its entirety.

### TECHNICAL FIELD

The present disclosure generally relates to a panel for a fencing system and, more particularly, to molded panels for a modular fencing system.

### BACKGROUND

A fence is a structure that encloses an area, typically outdoors. There are many perimeter fencing solutions commercially available. Generally, a fence around a property or area involves installing in the ground a number of posts spaced apart to receive individual connecting rails and fence panels/wires. A fence differs from a wall in that the fence typically does not have a solid foundation along its whole length.

### SUMMARY

A fencing system includes a fence panel having a mesh first portion and a solid second portion. That is, the second portion has a smooth or continuous or uninterrupted outer surface along at least one side of the fence panel, such as to preclude animals from climbing or going through holes in the panel. The second portion of the fence panel accommodates a sheet of reinforcement material that is joined to the fence panel during an injection molding technique.

For example, a method for forming the fence panel includes providing a mold including a cavity configured to receive a molten material (e.g., a thermoplastic resin). Reinforcement material is disposed within the cavity of the mold. With the reinforcement material disposed within the cavity of the mold, the molten material is injected into the cavity of the mold and the injected molten material flows within the cavity of the mold. After injecting the molten material into the cavity of the mold, and with the molten material cooled to harden, a formed fence panel is removed from the cavity of the mold. The formed fence panel includes the first portion having a pattern of apertures extending through the formed fence panel and the second portion accommodating the reinforcement material and having the smooth or continuous or uninterrupted outer surface at the first side of the formed fence panel.

A mold for forming the fence panel may include a first mold portion and a second mold portion that join together to form a cavity of the mold between the first mold portion and the second mold portion. With the first mold portion and the second mold portion joined together, the cavity is configured to receive the molten material that flows within the cavity of the mold. With the molten material cooled to harden, the formed fence panel is removable from the cavity of the mold. With the first mold portion and the second mold portion joined together, (i) a first region of the cavity corresponds to a first portion of the formed fence panel and (ii) a second region of the cavity corresponds to a second portion of the formed fence panel.

These and other objects, advantages, purposes and features of the present invention will become apparent upon review of the following specification in conjunction with the drawings.

### BRIEF DESCRIPTION OF THE DRAWINGS

FIG. 1 is a plan view of a fence panel of a fencing system;

FIG. 1A is a cross-sectional view taken along line A-A of FIG. 1;

FIG. 1B is an enlarged view of area B in FIG. 1;

FIG. 1C is an enlarged view of area C in FIG. 1A;

FIG. 2 is a plan view of another fence panel;

FIG. 2A is a cross-sectional view taken along line A-A of FIG. 2;

FIG. 2B is an enlarged view of area B in FIG. 2;

FIG. 2C is an enlarged view of area C in FIG. 2A;

FIG. 3 is a plan view of another fence panel;

FIG. 3A is a cross-sectional view taken along line A-A of FIG. 3;

FIG. 3B is an enlarged view of area B in FIG. 3;

FIG. 3C is an enlarged view of area C in FIG. 3A;

FIG. 4 is a plan view of another fence panel;

FIG. 4A is a cross-sectional view taken along line A-A of FIG. 4;

FIG. 4B is an enlarged view of area B in FIG. 4; and

FIG. 4C is an enlarged view of area C in FIG. 4A.

### DETAILED DESCRIPTION

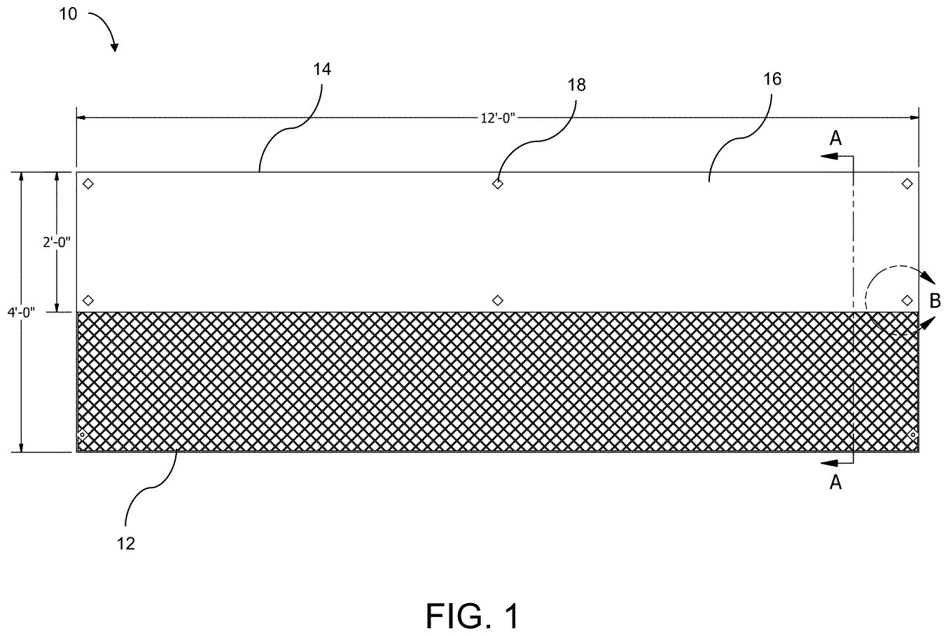

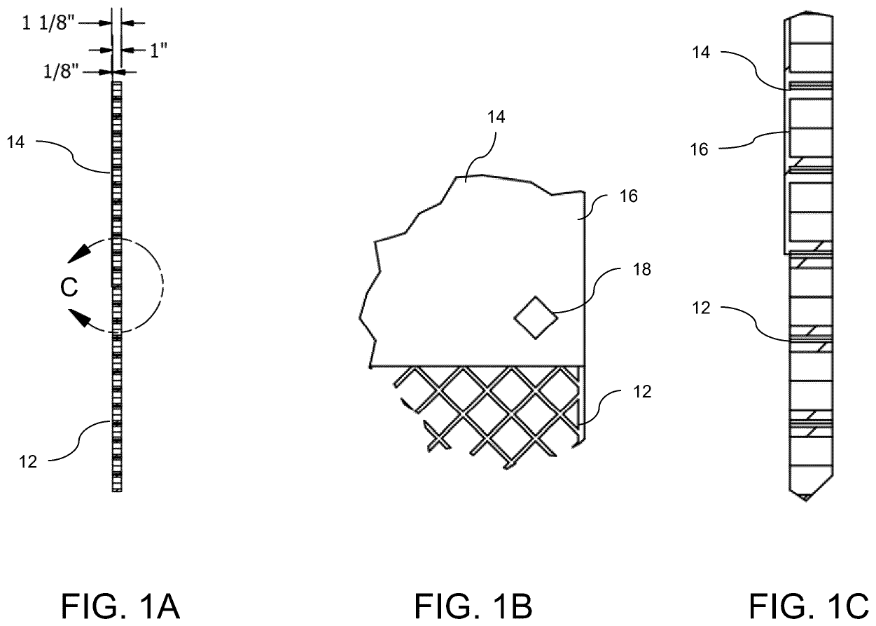

Referring now to the drawings and the illustrative embodiments depicted therein, a fencing system may include a series of vertical posts (not shown) anchored to a ground surface, such as a concrete slab, a concrete footing, or earth, and spaced from one another, with horizontal connecting rails (not shown) extending between respective ones of the vertical posts. Fence panels 10 are supported at the vertical posts and/or the horizontal connecting rails and extend between the vertical posts to form a continuous barrier (FIG. 1). For example, the fencing system may be installed along the perimeter of a property or surrounding a restricted area, such as a power transformer or construction site, to prevent unauthorized crossing of the barrier. The fencing system may include characteristics of the fencing systems described in U.S. Pat. Nos. 12,110,704; 12,098,567; 11,180,928 and/or 10,221,586, which are hereby incorporated herein by reference in their entireties.

To comply with animal mitigation standards, such as those established by the Institute of Electrical and Electronics Engineers (IEEE) to guide animal mitigation for electric power supply substations, each fence panel 10 may include a sheet or panel of material that includes a mesh first portion or section 12 and a solid second portion or section 14. In other words, each fence panel 10 includes two or more regions or portions of the fence panel 10 having different patterns or configurations of solid material and/or apertures, indentations, protrusions, and the like. In the illustrated example, the first portion 12 has a mesh pattern or configuration and the second portion 14 has a solid pattern or configuration.

The solid portion 14 thus includes a substantially smooth or continuous or uninterrupted outer surface at least at one side of the fence panel 10, such as the side of the fence panel 10 facing away from the restricted area. As discussed further below, the opposite side of the solid portion 14 may include any suitable configuration, such as a series of recesses that do not pass through the thickness of the solid portion 14. Thus, the solid portion 14 of the fence panel 10 may preclude the passage of material (e.g., water, airflow, dust, animals and the like) through the solid portion 14 of the fence panel 10 and may prevent someone from viewing through the solid portion 14 of the fence panel 10.

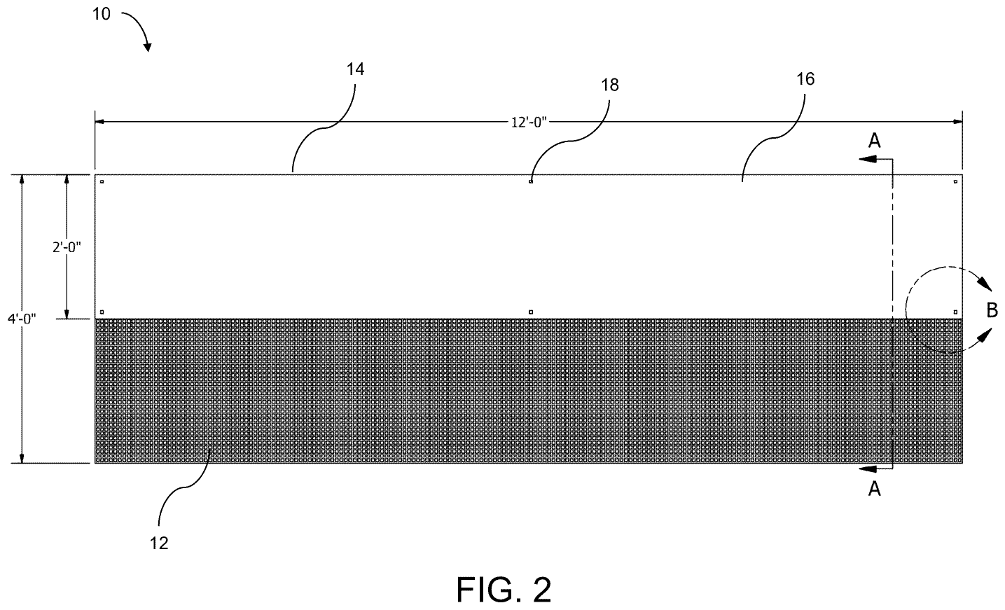

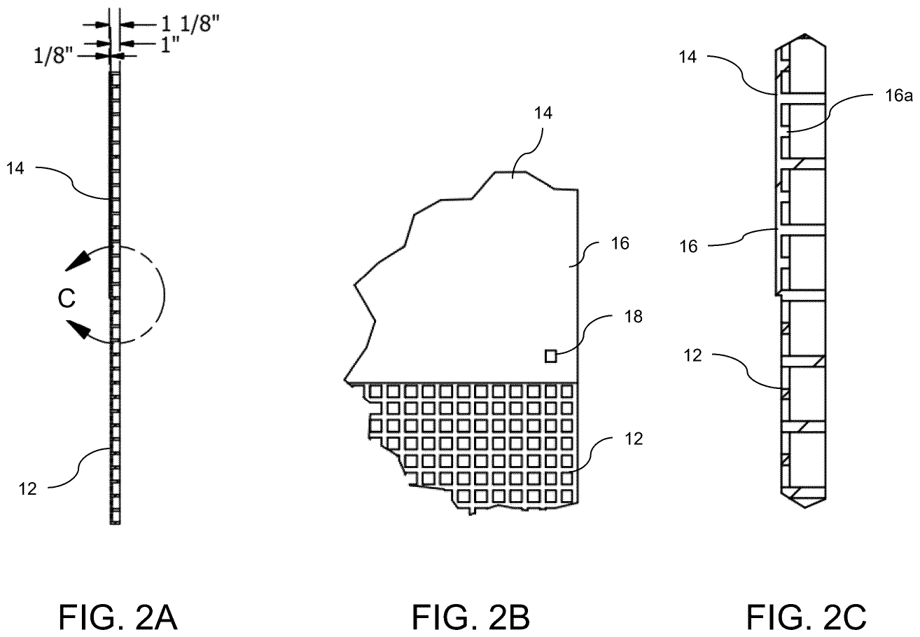

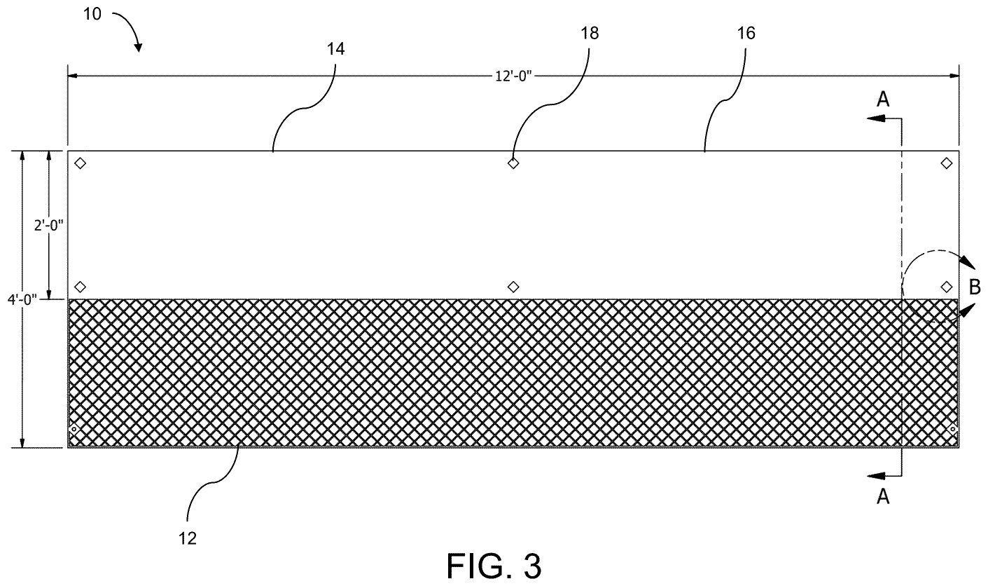

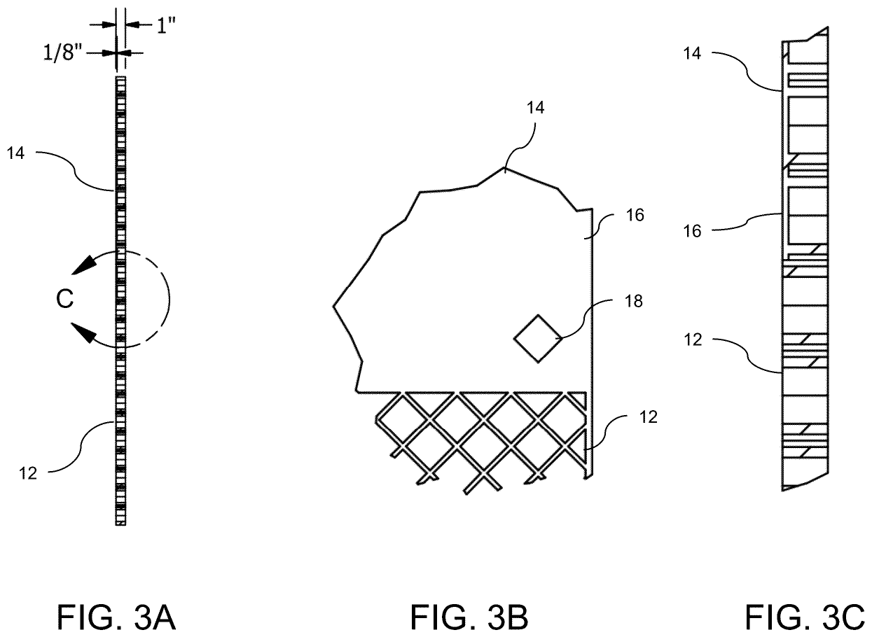

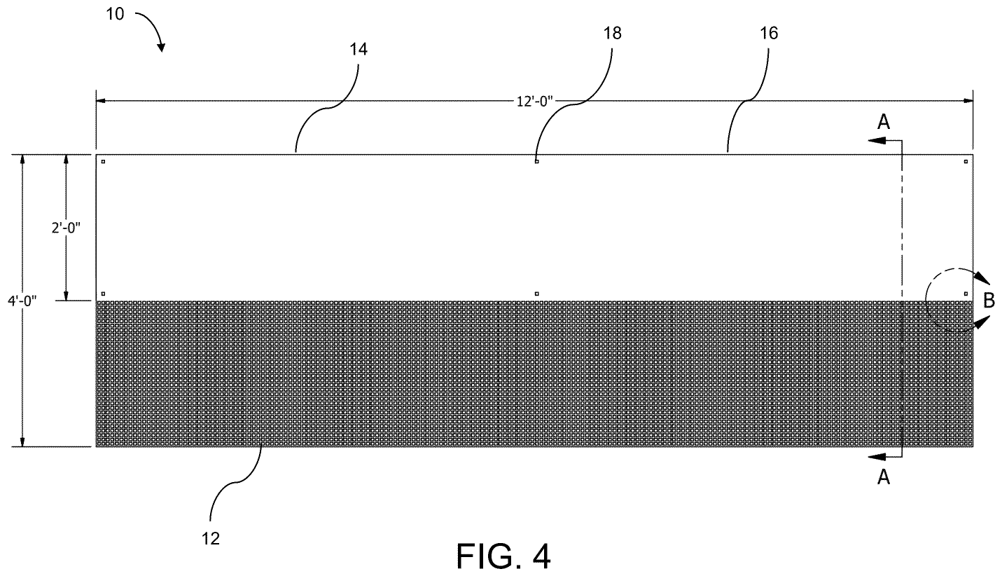

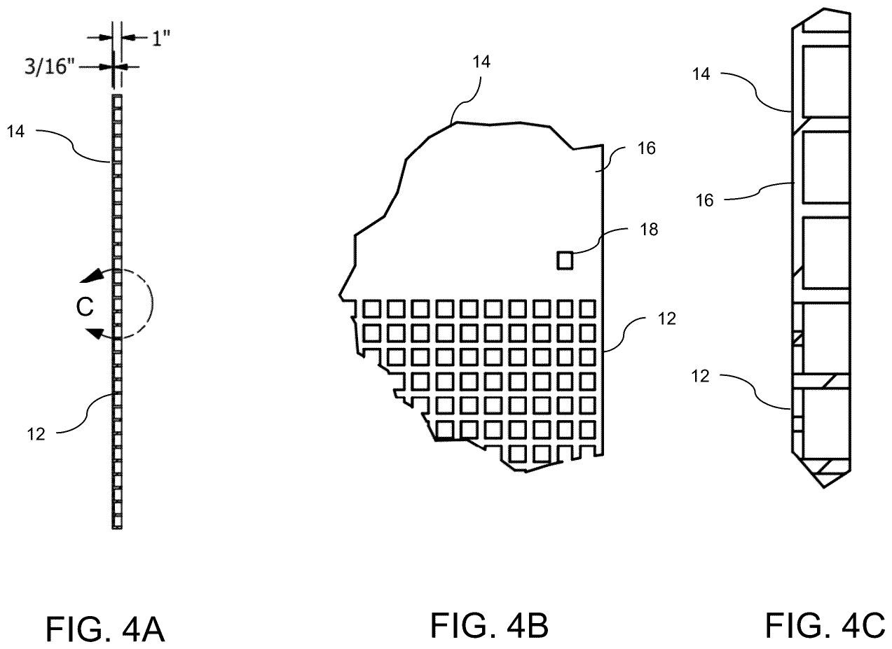

The first portion 12 of the fence panel 10 includes a plurality of apertures or openings extending through the thickness of the fence panel 10, where the apertures may have any suitable shape and may form any regular or irregular pattern or configuration. Thus, the mesh portion 12 of the fence panel 10 may allow for the passage of some material (e.g., water, airflow, dust, and the like) through the mesh portion 12 while preventing the passage of other materials (e.g., animals, debris, and the like). The mesh pattern may have any suitable configuration, such as a diamond hole pattern (e.g., FIGS. 1 and 3), a square or rectangular hole pattern (e.g., FIGS. 2 and 4), a circular or rounded hole pattern, a combination of holes in any suitable shape forming a pattern, and the like. The fence panel 10 may include patterns forming any suitable design at the fence panel 10 or across a plurality of adjacent fence panels 10, such as a pattern representing an image graphic (e.g., a logo or icon), a pattern forming a geometric design (e.g., a wave or zig zag) or a pattern representing a wordmark (e.g., a label or name for the restricted area or a company name).

The mesh first portion 12 may correspond to a lower half or region of the fence panel 10 and the solid second portion 14 may correspond to an upper half or region of the fence panel 10. Thus, when the fence panel 10 is installed as part of the fencing system, the mesh first portion 12 may extend from a lower edge region of the fence panel 10 at or near the ground surface and the solid second portion 14 may extend between the mesh first portion 12 and an upper edge region of the fence panel 10. The solid second portion 14 may be positioned along the upper portion of the fence panel 10 to preclude animals (e.g., squirrels, lizards, and the like) from climbing over the fence and into the restricted area. That is, the solid second portion 14 does not provide structure for animals to grip when attempting to scale the fence and thus reduces risk of entry into the restricted area. Optionally, the solid second portion 14 may be positioned along the lower portion of the fence panel 10 (and optionally disposed at least partially beneath the ground surface), such as to preclude formation of a hole through the fence panel 10 and/or burrowing beneath the fence panel 10. The mesh portion 12 of the fence panel 10 may allow for movement of airflow and/or water through the fence panel 10 to reduce stress on the fence assembly.

The fence panel 10 may be formed via injection molding. That is, a cavity of a mold or form may be injected with molten material (e.g., a thermoplastic resin) and allowed to cool and harden to form the fence panel 10. The cavity of the mold is representative of the formed shape of the fence panel 10 and thus may include structure within the cavity that defines the patterns of the first portion 12 and/or the second portion 14. Further, reinforcement structure or material (such as glass or carbon fibers) may be disposed along at least portions of the cavity of the mold to line those portions of the mold cavity prior to injecting the molten material to reinforce the portion of the formed fence panel 10 containing the reinforcement material (or fibers may be mixed with the molten material prior to injecting the resin or molten material, whereby the non-reinforced resin and the reinforced resin may be molded via a two-shot molding process). In other words, the fence panel 10 may comprise a fiber reinforced plastic (FRP) panel.

As discussed further below, the molded fence panel 10 may have a mesh pattern that spans the first portion 12 and the second portion 14, where a solid sheet 16 of reinforced plastic is integrally formed with the second portion 14 of the panel 10 to provide the smooth outer surface of the panel 10 at one side of the second portion 14 and a mesh pattern of recesses at the other side of the second portion 14 following the injection molding process. For example, the solid sheet 16 of reinforced plastic may include a sheet of reinforcement material disposed as a sheet into the mold cavity or a lining or layer of reinforcement material integrated at least partially within the hardened resin.

Optionally, the structure within the cavity of the mold may define the mesh pattern of the fence panel 10 that spans the first portion 12 and the second portion 14, with the thickness or depth of the cavity of the mold increased at the portion of the mold corresponding to the second portion 14 to accommodate placement of the layer or sheet of reinforcement material within the portion of the mold corresponding to the second portion 14 of the panel 10 prior to injection of the resin material. That is, the part of the mold structure defining the mesh pattern (e.g., structure of the mold restricting flow of molten material within the cavity) may have a uniform thickness or depth spanning the fence panel 10, with a thickness or depth of the cavity of the mold increased at the second portion 14 to accommodate the solid sheet of reinforcement material (or optionally to allow for molten material to flow and form a solid sheet of material) for formation of the sheet 16 of reinforced plastic. For example, the mold may include a first portion or half and a second portion or half that join together to form the cavity of the mold between the first portion and the second portion. The first portion of the mold may include projections that extend within the cavity of the mold from the first portion toward the second portion such that, when the resin material fills the cavity of the mold, the projections define the mesh pattern of apertures and recesses. To form the mesh portion 12 of the fence panel 10, the projections may engage the second portion of the mold so that no resin material may flow between the projections and the second portion of the mold. To form the solid portion 14 of the fence panel 10, a space or gap may be between the ends of the projections and the second portion of the mold so that resin material may flow between and fill the gap between the projections and the second portion of the mold. The sheet of reinforcement material may be disposed in the gap between the projections and the second portion of the mold. Thus, at least the second portion of the fence panel comprises a fiber reinforced plastic (FRP) panel, while the first portion of the fence panel may not include the reinforcement material.

For example, and as shown in FIGS. 1 and 1A-1C, after formation of the panel 10, the first portion 12 has a diamond hole mesh pattern and the second portion 14 has the diamond hole mesh pattern visible at one side of the panel 10 and the solid sheet 16 extends along the other side of the panel 10 at the second portion 14 to cover the holes and form a smooth outer surface of the panel 10 at that side. The solid sheet 16 extends from the mesh pattern at the one side of the panel 10 such that the second portion 14 of the panel 10 has a greater thickness than the first portion 12 of the panel 10. That is, the mold may have a greater thickness or depth of the cavity at the portion corresponding to the second portion 14 of the fence panel 10 to form the gap between the projections and the second portion of the mold and allow for formation of the solid sheet 16.

The layer or sheet of reinforcement material may at least partially bond to or adhere to the molten material (or be at least partially encased by the molten material) during the injection molding process such that the solid sheet 16 of reinforced plastic is integrally formed with the mesh of the second portion 14 (e.g., FIG. 1C). In other words, the formed second portion 14 of the panel 10 may include a solid structure having a solid or continuous surface at one side of the panel 10 and the mesh pattern of recesses at the other side of the panel 10. Fasteners 18, such as diamond clips or tabs secured via threaded fasteners extending through the clips and fence panel 10, may further secure the solid sheet 16 at the second portion 14 of the panel 10 and preclude the solid sheet 16 from separating from the mesh part of the second portion 14. For example, the fasteners 18 may be disposed about a perimeter region of the second portion 14.

Optionally, the layer or sheet of reinforcement material may at least partially fill gaps or holes of the mesh pattern at the second portion. For example, and as shown in FIGS. 2 and 2A-2C, the sheet of reinforcement material may include projections 16a configured to extend at least partially within gaps or holes of the mesh pattern at the second portion 14. This may result in more secure attachment of the solid sheet 16 of reinforced plastic at the second portion 14.

In some examples, the mold may define the mesh pattern of the fence panel 10 that spans the first portion 12 and the second portion 14, with the thickness of the part of the mold defining the mesh pattern (e.g., the projections of the first portion of the mold) reduced relative to the cavity at the portion of the mold corresponding to the second portion 14. This reduced thickness of the structure defining the mesh pattern accommodates placement of the sheet of reinforcement material within the portion of the cavity corresponding to the second portion 14 of the panel 10 prior to injection of the resin material. In other words, the part of the mold defining the mesh pattern may have a first thickness corresponding to the first portion 12 of the panel 10 and a second thickness corresponding to the second portion 14 of the panel 10 where the second thickness is less than the first thickness to accommodate the reinforcement material (or optionally to allow molten material to flow and form a solid sheet of material) during formation of the solid sheet 16 of reinforced plastic. This may result in the fence panel 10 having a uniform thickness spanning the first portion 12 and the second portion 14 while retaining the apertures at the first portion 12 and the solid surface at the second portion 14.

For example, and as shown in FIGS. 3, 3A-3C, 4 and 4A-4C, after formation of the panel 10, the first portion 12 has a diamond hole mesh pattern and the second portion 14 has the diamond hole mesh pattern visible at one side of the panel 10 and the solid sheet 16 extends along the other side of the panel 10 at the second portion 14 to cover the holes and form a smooth outer surface of the panel 10 at that side. Because the mesh pattern at the second portion 14 has a reduced thickness, an outer surface of the solid sheet 16 may be generally coplanar or flush with an outer surface of the mesh first portion 12. The sheet of reinforcement material may at least partially bond to or adhere to the molten material (or be at least partially encased by the molten material) during the injection molding process such that the solid sheet 16 of reinforced plastic is integrally formed with the mesh of the second portion 14 and/or the mesh of the first portion 12 (e.g., FIGS. 3C and 4C). Thus, the panel 10 with the integrated solid sheet 16 and reduced thickness mesh pattern at the second portion 14 provides a panel having uniform thickness, which may require a reduced amount of material and allow for flush mounting of the panel 10 at the fencing system.

Optionally, the fence panel may be formed via a two shot molding process where the second portion is overmolded onto the first portion. In other words, a fence panel having a mesh pattern spanning the entirety (or substantially across the entirety) of the fence panel may be formed, such as via a first injection molding step or via a metal fabrication process (e.g., weaving of metal wires to form the mesh pattern or punching and expanding a metal sheet to form the mesh pattern). The formed mesh panel may then be disposed into a cavity of a mold and the mold may be injected with molten material to form the second portion having the smooth outer surface. Reinforcement material, such as reinforcement fibers or a sheet of reinforcement material, may be disposed within the cavity prior to injecting the molten material so that at least the second portion of the formed fence panel is a FRP panel. Optionally, the mesh panel may also be overmolded at the first portion of the fence panel such that the metallic mesh is overmolded with cooled and hardened plastic material, with the pattern of apertures still formed through the first portion of the fence panel.

In some examples, the fence panel may be formed via a two-step process where the second portion is attached, such as permanently attached via adhesive, fasteners and the like, to the first portion. In other words, the mesh first portion and the solid second portion may be formed separate from one another, such as via injection molding steps or via metal fabrication processes. Optionally, the solid second portion may be formed via injection molding or non-molding techniques such as pultrusion. The formed panel having a continuous outer surface may then be attached to the formed mesh panel. Optionally, the panel having the continuous outer surface may include one or projections that extend from a rear side of the panel and through openings in the mesh panel, such as to help secure or position the solid panel at the mesh panel.

FIGS. 1, 1A, 2, 2A, 3, 3A, 4 and 4A include example dimensions of the fence panels. For example, each panel 10 may have a width of 12 feet and a height of 4 feet, where each of the first portion 12 and the second portion 14 spans the width of the panel 12 with the first portion 12 spanning the lower 2 feet of the panel 10 and the second portion 14 spanning the upper 2 feet of the panel 10. Optionally, the first portion 12 may span the upper 2 feet of the panel 10 and the second portion 14 may span the lower 2 feet of the panel 10. When the thickness of the mold is increased at the part corresponding to the second portion 14 to accommodate the sheet of reinforcement material (e.g., FIGS. 1, 1A, 2 and 2A), the resulting panel 10 may have a thickness of 1 inch at the first portion 12 and a thickness of 1.125 inches at the second portion 14, with the mesh pattern at the second portion 14 having a thickness of 1 inch and the solid sheet 16 of reinforced plastic having a thickness of 0.125 inches. When the thickness of the part of the mold forming the mesh pattern is decreased at the part corresponding to the second portion 14 to accommodate the sheet of reinforcement material (e.g., FIGS. 3, 3A, 4 and 4A), the resulting panel 10 may have a thickness of 1 inch at the first portion 12 and the second portion 14, with the mesh pattern at the second portion 14 having a thickness of 0.875 inches and the solid sheet 16 of reinforced plastic having a thickness of 0.125 inches. It should be understood that the panel 10 may have any suitable dimension. For example, the panel may have a thickness of 2 inches, 2.125 inches, and the like.

In other words, the fence panel may include mesh patterns with open square, rectangle, or diamond patterns of various sizes and thicknesses combined with solid sections. This is beneficial in animal mitigation. The molding process may be differentiated from a manufacturing process to form skip mesh expanded metal panels. For example, the molds may have a different depth depending on panel thickness. That is, a mold designed to produce fully mesh panels and having dimensions of 4 feet by 12 feet by 2 inches may be increased to have a depth of the mold of 2.125 inches along the portion of the mold corresponding to the solid section of the panel (e.g., along the top 2 feet of the mold) to accommodate a solid sheet of fibers prior to adding the resin. This results in a panel having two different thicknesses, with a thickness of 2 inches for the open diamond mesh section and a thickness of 2.125 inches for the section with diamonds and integrated solid sheet.

In another example, the mold designed to produce fully mesh panels may be reduced to have a depth of 1.875 inches along the portion of the mold corresponding to the solid section of the panel to accommodate a solid sheet of fibers attached to the formed panel at the reduced section. This results in a panel having a consistent thickness of 2 inches, with the thickness of the mesh diamonds in the solid section being 1.875 inches compared to the thickness of the mesh diamonds in the open section being 2 inches.

Changes and modifications in the specifically described embodiments may be carried out without departing from the principles of the present invention, which is intended to be limited only by the scope of the appended claims as interpreted according to the principles of patent law.

1. A method for forming a fence panel, the method comprising:
providing a mold comprising a cavity configured to receive a molten material;
injecting the molten material into the cavity of the mold, wherein the injected molten material flows within the cavity of the mold;
after injecting the molten material into the cavity of the mold, and with the molten material cooled to harden, removing a formed fence panel from the cavity of the mold; and
wherein the formed fence panel comprises (i) a first portion having a pattern of apertures extending through the formed fence panel and (ii) a second portion having a continuous outer surface at least at a first side of the formed fence panel.

2. The method of claim 1, further comprising, prior to injecting the molten material into the cavity of the mold, disposing reinforcement material within the cavity of the mold, wherein the reinforcement material is disposed at least at the second portion of the formed fence panel.

3. The method of claim 2, wherein the reinforcement material comprises a sheet of reinforcement material.

4. The method of claim 2, wherein the reinforcement material comprises a fibrous material.

5. The method of claim 2, wherein the reinforcement material comprises a metallic mesh, and wherein the metallic mesh is disposed at the first portion and the second portion of the formed fence panel.

6. The method of claim 1, wherein the first portion of the formed fence panel comprises a first thickness and the second portion of the formed fence panel comprises a second thickness, and wherein the first thickness is different from the second thickness.

7. The method of claim 6, wherein the first thickness is less than the second thickness.

8. The method of claim 1, wherein the first portion of the formed fence panel and the second portion of the formed fence panel comprise a uniform thickness.

9. The method of claim 1, wherein the second portion of the formed fence panel has a pattern of recesses formed at a second side of the formed fence panel opposite the first side, and wherein the pattern of recesses corresponds to the pattern of apertures of the first portion.

10. The method of claim 9, wherein the mold comprises structure within the cavity of the mold, and wherein the structure comprises an arrangement that spans the first portion and the second portion of the formed panel, and wherein the molten material flows within the cavity of the mold around the structure such that, with the molten material cooled to harden, the arrangement of the structure corresponds to (i) the pattern of apertures of the first portion of the formed fence panel and (ii) the pattern of recesses of the second portion of the formed fence panel.

11. The method of claim 10, wherein the structure of the mold comprises (i) a first thickness that corresponds to the pattern of apertures of the first portion of the formed fence panel and (ii) a second thickness that corresponds to the pattern of recesses of the second portion of the formed fence panel, and wherein the second thickness is less than the first thickness to allow the molten material to flow within the cavity of the mold and form the continuous outer surface at least at the first side of the second portion of the formed fence panel.

12. The method of claim 10, wherein the structure of the mold comprises a uniform thickness at portions of the mold that correspond to the first portion and the second portion of the formed panel.

13. The method of claim 10, wherein the structure comprises a plurality of projections extending at least partially within the cavity of the mold.

14. The method of claim 1, wherein the molten material comprises a thermoplastic resin.

15. A fence panel, the fence panel comprising:
a first portion having a pattern of apertures extending through the fence panel;
a second portion having a continuous outer surface at least at a first side of the fence panel, wherein the second portion includes reinforcement material; and
wherein the first portion is formed via an injection molding process.

16. The fence panel of claim 15, wherein the first portion comprises a first thickness and the second portion comprises a second thickness, and wherein the first thickness is different from the second thickness.

17. The fence panel of claim 16, wherein the first thickness is less than the second thickness.

18. The fence panel of claim 15, wherein the first portion and the second portion comprise a uniform thickness.

19. The fence panel of claim 15, wherein the second portion has a pattern of recesses formed at a second side of the fence panel opposite the first side, and wherein the pattern of recesses corresponds to the pattern of apertures of the first portion.

20. The fence panel of claim 15, wherein the reinforcement material is integrated into the second portion of the fence panel during the injection molding process.

21. The fence panel of claim 15, wherein the first portion does not include reinforcement material.

22. The fence panel of claim 15, wherein the reinforcement material comprises a sheet of reinforcement material.

23. The fence panel of claim 15, wherein the reinforcement material comprises a fibrous material.

24. The fence panel of claim 15, wherein the first portion and the second portion are formed together via a common injection molding process.

25. The fence panel of claim 15, wherein the first portion is formed via a first shot of the injection molding process and the second portion is formed via a second shot of the injection molding process.

26. The fence panel of claim 15, wherein the first portion is formed via a first injection molding process and the second portion is formed via a second injection molding process, and wherein the second portion is joined to the first portion following the first injection molding process and the second injection molding process.

27. The fence panel of claim 15, wherein the second portion is formed via a pultrusion process.

28. A mold for forming a fence panel during an injection molding process, the mold comprising:
a first mold portion and a second mold portion that join together to form a cavity of the mold between the first mold portion and the second mold portion;
wherein, with the first mold portion and the second mold portion joined together, the cavity is configured to receive a molten material that flows within the cavity of the mold, and wherein, with the molten material cooled to harden, a formed fence panel is removable from the cavity of the mold;
wherein, with the first mold portion and the second mold portion joined together, (i) a first region of the cavity corresponds to a first portion of the formed fence panel and (ii) a second region of the cavity corresponds to a second portion of the formed fence panel; and
wherein the first portion of the formed fence panel comprises a pattern of apertures extending through the formed fence panel, and wherein the second portion of the formed fence panel comprises a continuous outer surface at least at a first side of the formed fence panel.

29. The mold of claim 28, wherein at least the second region of the cavity of the mold is configured to receive reinforcement material such that the reinforcement material is disposed at least at the second portion of the formed fence panel.

30. The mold of claim 29, wherein the reinforcement material comprises a sheet of reinforcement material.

31. The mold of claim 29, wherein the reinforcement material comprises a fibrous material.

32. The mold of claim 29, wherein the reinforcement material comprises a metallic mesh, and wherein the metallic mesh is disposed at the first portion and the second portion of the formed fence panel.

33. The mold of claim 28, wherein the first mold portion comprises a plurality of projections (i) that extend from the first mold portion toward the second mold portion at least within the first region of the cavity and (ii) that corresponds to the pattern of apertures of the first portion of the formed fence panel.

34. The mold of claim 33, wherein the second portion of the formed fence panel comprises a pattern of recesses formed at a second side of the formed fence panel opposite the first side, and wherein the plurality of projections (i) extend from the first mold portion toward the second mold portion within the second region of the cavity and (ii) corresponds to the pattern of recesses of the second portion of the formed fence panel.

35. The mold of claim 34, wherein the first region of the cavity comprises a first depth corresponding to a first thickness of the formed fence panel, and wherein the second region of the cavity comprises a second depth greater than the first depth corresponding to a second thickness of the formed fence panel greater than the first thickness, and wherein the plurality of projections have a uniform length relative to the first mold portion at the first region of the cavity and at the second region of the cavity.

36. The mold of claim 34, wherein the first region of the cavity and the second region of the cavity comprise a uniform depth corresponding to an equal thickness of the first portion of the formed fence panel and the second portion of the formed fence panel, and wherein the plurality of projections at the first region of the cavity have a first length relative to the first mold portion, and wherein the plurality of projections at the second region of the cavity have a second length relative to the first mold portion less than the first length.
